(19) United States
(12) Patent Application Publication
(10) Pub. No.: US 2004/0011229 A1
(43) Pub. Date: Jan. 22, 2004

(54) Satellite-type printing press

(75) Inventor: Masayuki Iwamoto, Shizuoka (JP)

Correspondence Address: Ladas & Parry, 26 West 61st Street, New York, NY, 10023, US

(73) Assignee: SHINOHARA MACHINERY CO., LTD

(21) Appl. No.: 10/196,044

(22) Filed: Jul. 16, 2002

(51) Int. Cl. B41F 5/16

(52) U.S. Cl. 101/174

(57) ABSTRACT

Sheet-fed printing press, especially, satellite-type printing press is disclosed by which double-side printing is performed with single satellite-type press and, in case sheet reversing is not needed, sheet perfecting apparatus does not intervene with sheet transfer path.

In the concrete, in the course of many printing units 26 which are provided in satellite-like manner around common pressure cylinder 10, sheet perfecting apparatus 36 which is separable from sheet transfer path is provided and the apparatus comprises first transfer cylinder 38, perfecting cylinder 40 and second transfer cylinder 42.

### BACKGROUND OF THE INVENTION

1. Field of the Invention

The present invention relates generally to sheet-fed printing press, or more precisely, to such printing press with sheet perfecting apparatus.

2. Description of the Prior Art

Satellite-type printing press is known in which many printing units (four color units, for example) are provided in satellite-like manner around common pressure cylinder of large diameter. Such satellite-type printing press is a new step toward corresponding to the need of multi-sort short run printing.

In Japanese unexamined patent laid-open 244195/1996, a technique is disclosed in which a plurality of satellite-type printing presses are connected via sheet perfecting apparatus. According to the technique, four color printing is done on the surface of sheet by first satellite-type press and, after reversing the sheet, also four color printing is put on the opposite side of the sheet by the second satellite-type press.

From Japanese unexamined patent laid-open 169645/1987, for example, a technique is well known in which many printing units are connected in series and sheet perfecting apparatus is interposed therein.

It is true that both sides of sheet can be printed at one pass by the satellite-type printing press shown in before-mentioned Japanese unexamined patent laid-open 244195/1996, but the equipment is huge and switching of printing format is not at all flexible, as the technique presupposes two satellite-type printing units.

Also, before-mentioned sheet perfecting apparatus of series type printing press has a tendency to cause register error through gripping change of sheet, as the perfecting apparatus stays the sheet transfer path during one-side printing in which sheet perfecting is not needed.

### SUMMARY OF THE INVENTION

In view of the above-described problems of the prior art technique, the present invention provides an improved satellite-type printing press and aims at enabling double-side printing by only one satellite-type printing press itself, and preventing register error without intervening with sheet transfer path in case sheet reversing is not needed.

In accordance with satellite-type printing press according to the present invention, in the course of printing units of one satellite-type press itself, sheet perfecting apparatus is provided which functions only in double-side printing for sheet reversing and, in case of one-side printing, does not intervene with sheet transfer path.

More concretely, satellite-type printing press according to the present invention comprises;

Common pressure cylinder with grippers for sheet transfer to which are connected sheet feeder in the upper stream of sheet transfer and sheet delivery in the lower stream,

at least four sets of printing units which are provided in satellite-like manner around said common pressure cylinder,

sheet perfecting apparatus which is provided in the course of printing units and separable from sheet transfer path,

and said apparatus comprises, from the upper stream to the down stream of sheet transfer path, first transfer cylinder, perfecting cylinder and second transfer cylinder.

According to the present invention, double-side printing of, for example, two colors on surface as well as two colors on backside is possible by only one satellite-type press in which sheet perfecting apparatus is provided between second and third printing units.

In one-side printing, sheet perfecting apparatus does not intervene with sheet transfer path, therefore, high register accuracy is secured even in four color printing.

These and other objects of the present invention will become apparent from the following description with reference to the drawings. But, these show merely an embodiment of the present invention.

### BRIEF DESCRIPTION OF THE DRAWINGS

FIG. 1 is a schematic view showing an embodiment of satellite-type printing press according to the present invention.

FIGS. 2 to 8 are functional illustrations of sheet perfecting apparatus provided in the satellite-type printing press according to the present invention.

FIG. 9 is a block diagram for controlling the speed of perfecting cylinder in sheet perfecting apparatus.

FIG. 10 is a speed diagram of perfecting cylinder in compliance with variation of sheet length.

### DESCRIPTION OF PREFERRED EMBODIMENT

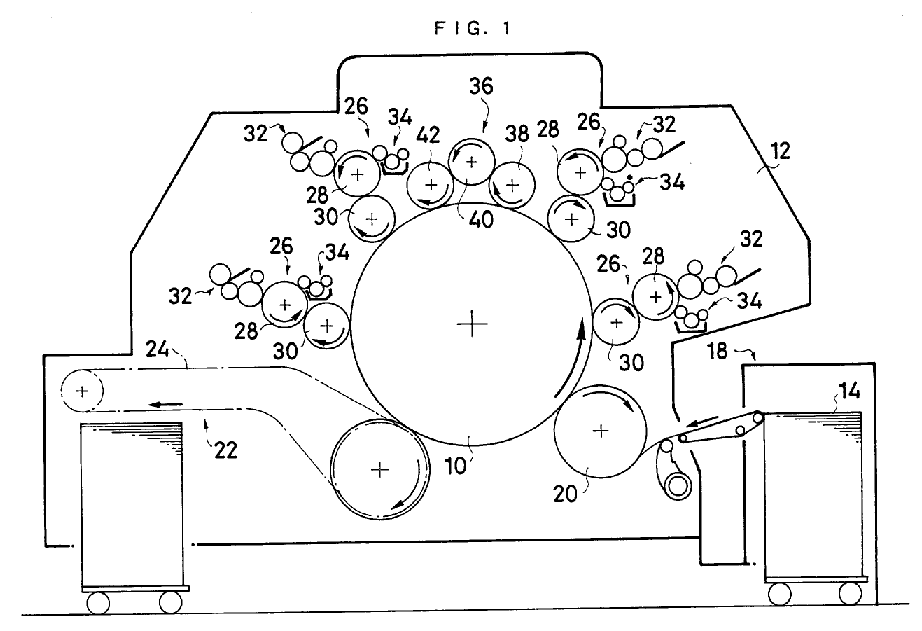

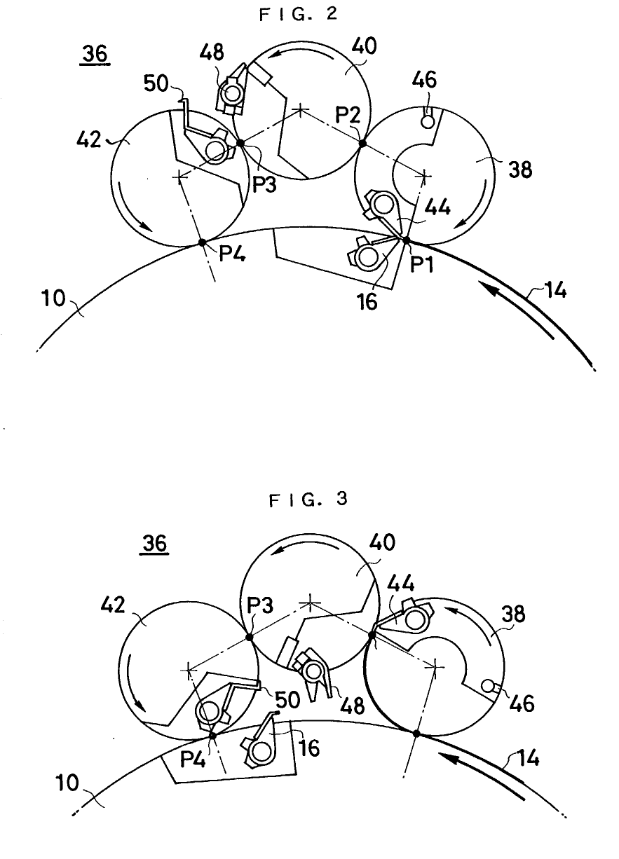

In the center of FIG. 1, common pressure cylinder 10 of relatively large diameter is shown which is rotatably supported between a pair of side frames 12 of printing press and is driven by motor (not shown). The common pressure cylinder 10 has, as shown in FIG. 2 and so on, grippers 16 which grip the end of sheet. The common pressure cylinder 10 is a base for accepting sheet 14 from feeding cylinder 20 of sheet feeder 18 in the upper stream and, after printing, for delivering the printed sheet to delivery chain 24 of sheet delivery device 22 in the lower stream.

Four sets of printing units 26 are provided in satellite-like manner around the common pressure cylinder 10. In order to perform offset printing, these printing units 26 have plate cylinder 28 equipped with printing plate and blanket cylinder 30 to transfer images. In addition, the plate cylinder 28 has inking device 32 and damping system 34. The diameter of the common pressure cylinder 10 around which printing units 26 are provided in satellite-like manner is integer times (for example, four times) as large as that of plate cylinder 28 in order to perform multi-color printing by these printing units 26 in compliance with the rotation of the common pressure cylinder 10 which is driven by motor (not shown).

Sheet perfecting apparatus 36 according to the present invention is provided between second and third printing units 26, basing upon rotational direction of common pressure cylinder 10 (counterclockwise in FIG. 1). From upper stream to down stream of sheet transfer path, the sheet perfecting apparatus 36 comprises first transfer cylinder 38, perfecting cylinder 40 and second transfer cylinder 42.

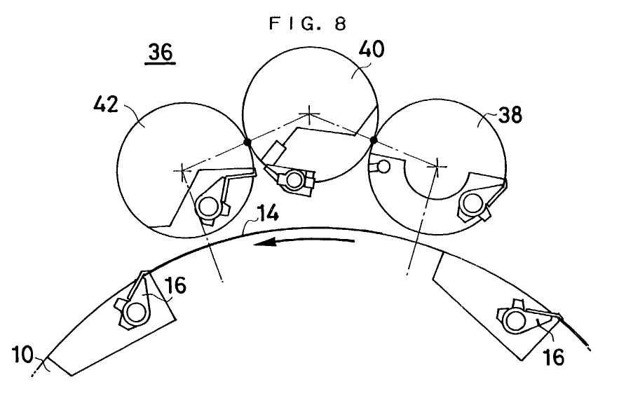

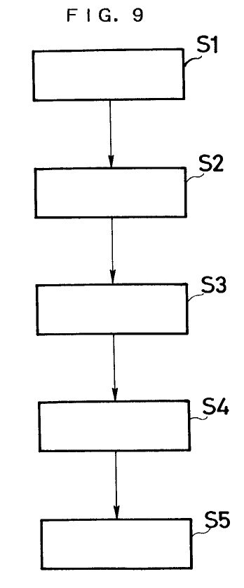

Such type of sheet perfecting apparatus 36 with three cylinders is well known in the prior art series-type printing press. Two transfer cylinders 38, 42 can, as shown in FIG. 8, be detachable from common pressure cylinder 10 by so-called cylinder throw-off. Needless to say, such cylinder throw-off (and throw-in as well) mechanism utilizing crank and cam is ordinarily equipped in blanket cylinder of offset press.

Next, sheet perfecting apparatus 36 is described with reference to functional illustrations of FIGS. 2 to 7. Two colors are printed on the surface of sheet 14 by blanket cylinder 30 of first and second printing units 26. Front end of sheet 14 is gripped by gripper 16 of common pressure cylinder 10 and then the front end is led to gripper 44 of first transfer cylinder 38 at opposing point P1 of common pressure cylinder 10 against first transfer cylinder 38 (FIG. 2).

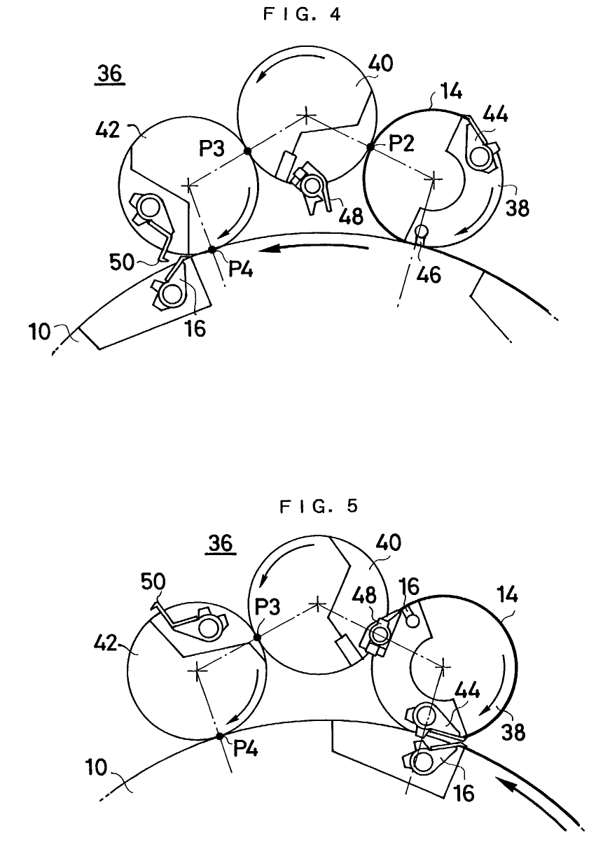

In accordance with the rotation of first transfer cylinder 38, front end reaches at opposing point P2 of first transfer cylinder 38 against perfecting cylinder 40 (FIG. 3), but sheet end is not transferred at this moment to perfecting cylinder 40 and rotation continues. Rear end of sheet 14 is sucked and broadened by sucker 46 (FIG. 4).

When rear end of sheet 14 reaches at opposing point P2 of perfecting cylinder 40, gripper 48 of perfecting cylinder 40 grips the rear end (FIG. 5) and, following the rotation of perfecting cylinder 40, sheet 14 is reversed.

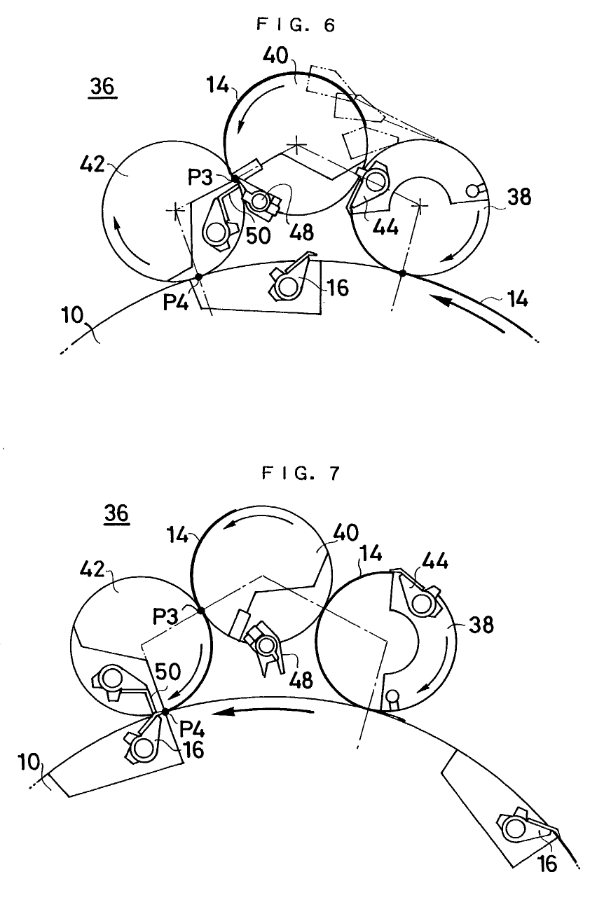

Reversed sheet 14 is then transferred to gripper 50 of second transfer cylinder 42 at opposing point P3 of perfecting cylinder 40 against second transfer cylinder 42 (FIG. 6) and further transferred to gripper 16 of common pressure cylinder 10 (FIG. 7).

Hereafter, third and fourth printing units 26 which are also provided in satellite-like manner around common pressure cylinder 10 further print on backside of sheet 14 which is already reversed by sheet perfecting apparatus 36 and finally double-side printing of two colors on surface as well as two colors on backside is completed.

In the foregoing descriptions, sheet 14 to be printed by satellite-type press according to the present invention is supposed to have a fixed length. But, sheet length (length of sheet 14 in its running direction.) is various and, under some conditions, sheet reversing pace must be raised in order to cope with printing speed. As described, press itself is, including each printing unit 26, timely driven by motor (not shown). To comply with sheet length variation to be printed, perfecting cylinder 40 of sheet perfecting apparatus 36 is preferably driven by servo motor (not shown) which is independent from motor of printing press. Further, servo motor speed is controlled in compliance with sheet length in its printing cycle so as to adapt sheet reversing pace to printing speed.

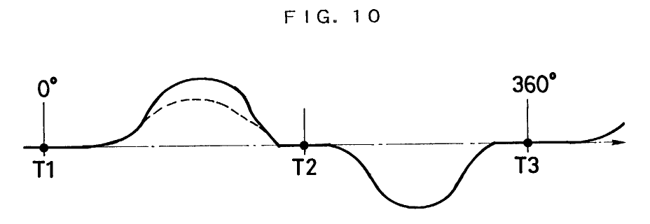

FIG. 9 is a block diagram, showing speed control of perfecting cylinder 40 by independent servo motor. Rotation speed of printing press is always monitored by, for example, rotary encoder (Step 1). In addition, sheet length is, prior to printing, input into control console of press (Step 2). In control console, speed control data for servo motor of perfecting cylinder 40 is created in compliance with input sheet length (Step 3) and, receiving speed control data, rotation speed of servo motor is in- or decreased (Step 4). Finally, rotation speed of perfecting cylinder 40 is, in its one printing cycle, adjusted (Step 5).

FIG. 10 schematically shows rotation speed variation of perfecting cylinder 40 in compliance with sheet length variation. Lateral axis shows rotation mode in one printing cycle from 0 to 360 degree and longitudinal axis shows rotation speed of perfecting cylinder 40. In sheet receiving section TI as well as sheet transferring section T2, relative speed of perfecting cylinder 40 in relation to first and second transfer cylinders 38, 42 is 0. But, after receiving sheet 14, rotation speed must be increased in compliance with sheet length in order to prepare sheet transfer. The case sheet length is long is shown in bold line and dot line shows the case sheet length is short.

According to the present invention, double-side printing of, for example, two colors on surface as well as two colors on backside can be done by only one satellite-type printing press. In surface printing (one-side printing), sheet perfecting apparatus does not intervene with sheet transfer path by so-called cylinder throw-off, therefore, high register accuracy is secured. Further, various sheet length can, without difficulty, be accepted.

The present invention is not limited to the embodiment described hitherto. Various changes and modifications can, of course, be made without departing from the spirit of the invention.

Description of the Reference Numerals

10 common pressure cylinder

14 sheet

16 gripper

18 sheet feeder

22 sheet delivery

24 delivery chain

26 printing unit

36 sheet perfecting apparatus

38 first transfer cylinder

40 perfecting cylinder

42 second transfer cylinder

44 gripper

46 sucker

48 perfecting gripper

50 gripper

What is claimed is:

1. Satellite-type printing press comprising, in the course of printing units 26 of one satellite-type press itself, sheet perfecting apparatus 36 which functions only in double-side printing for sheet reversing and, in one-side printing, does not intervene with sheet transfer path.

2. Satellite-type printing press comprising:
common pressure cylinder 10 with grippers 16 for sheet transfer to which are connected sheet feeder 18 in the upper stream of sheet transfer and sheet delivery 22 in the lower stream,
at least four sets of printing units 26 which are provided in satellite-like manner around said common pressure cylinder 10,
sheet perfecting apparatus 36 which is provided in the course of printing units 26 and separable from sheet transfer path,
and said apparatus 36 comprises, from the upper stream to the down stream of sheet transfer path, first transfer cylinder 38, perfecting cylinder 40 and second transfer cylinder 42.
